(19) United States
(12) Patent Application Publication
(10) Pub. No.: US 2001/0035417 A1
(43) Pub. Date: Nov. 1, 2001

(54) Resealable cup-shaped beverage container

(76) Inventors: Deborah Eve Kantor, Bala Cynwyd, PA (US); Jonathan Kantor, Bala Cynwyd, PA (US)

Correspondence Address: DEBORAH E. KANTOR, 101 SUMMIT LANE M-2, BALA CYNWYD, PA, 19004, US

(21) Appl. No.: 09/851,737

(22) Filed: May 9, 2001

Related U.S. Application Data
(60) Provisional application No. 60/203,311, filed on May 10, 2000.
(60) Provisional application No. 60/204,530, filed on May 16, 2000.

(51) Int. Cl. A47J 39/00; A47J 41/00; B65D 81/38; B65D 83/72

(52) U.S. Cl. 220/592.17

(57) ABSTRACT

A wide-mouthed beverage container in the shape of a cup, mug, glass, carafe, flute, bottle, can, or other form, in a variety of sizes, with a resealable cap or closure. This container may be recycleable, reusable, or disposable. The purpose of this invention is to provide a superior alternative to the traditional shapes of the openings of cold beverage containers. This cup-shaped container provides a large and open mouth as found in an ordinary household cup, glass, or mug, but can be purchased ready-to-drink with a beverage, and is either reusable or purchased for single-use, as desired by the consumer. Further, said beverage container may also incorporate a snack atop the beverage container. The wide-mouthed shape of said beverage container is particularly conducive to packaging with a snack food. This food and beverage item would be primarily for single-time use and therefore would be disposable or recyclable, although the cup could be reused.

REFERENCES TO US PATENTS

6,079,586 Hanneman Jun. 27, 2000

5,664,671 Nedblake, Jr. Sep. 9, 1997

5,960,973 Markson Oct. 5, 1999

5,727,679 Newarski Mar. 17, 1998 206/222

5,613,620 Center et al. Mar. 25 ,1997 221/133

5,310,072 Matusovsky May. 10, 1994 220/23.83

5,209,348 Schafer May. 11, 1993 206/222

5,180,079 Jeng Jan. 19, 1993 220/705

5,361,935 Sagucio Nov. 1994 220/709

4,796,774 Nabinger Jan. 1989 220/90.4

4,561,557 Park et al. Dec. 1985 220/90

4,219,137 Hutchens Aug. 1980 222.462

4,090,660 Schram et al. May. 1978 229/43

### TECHNICAL FIELD OF INVENTION

This invention is related to beverage containers and more particularly cup-shaped containers that may come with a beverage and food item attached as one unit.

### BACKGROUND OF INVENTION

Most beverages sold today, whether housed in glass, plastic or aluminum, are shaped in the form of a bottle or can with a small opening. Marketing strategies such as creating a subtly larger or wider opening from which to drink have appealed to consumers. The purpose of this invention is to provide a beverage container that is convenient to drink from, easy to handle, and possibly more formal than traditional beverage containers. The cup or glass-shaped container is primarily designed as a single-serve container, but may be resealable, for convenience as with a traditional resealable glass or plastic bottle. The open-mouth shape of the container eliminates the need for a glass or cup, since these secondary containers are generally used when consumers do not wish to drink directly from the small opening in a can or bottle. This beverage container may be used to house drinks such as juices, water, coffee or milk-based drinks, as well as carbonated soft drinks such as mineral water, colas, and even beers and ales.

Consumers enjoy buying fountain drinks, in part due to the convenience of drinking from a cup, with or without a straw. However, unlike this invention, fountain drinks cannot be resealed well enough to prevent unwanted spills, and it takes the consumer time to select a beverage and fill their cup. U.S. Pat. No. 5,361,935 involves a spill-resistant cup for housing soft-drinks. The purpose is to prevent spills that are common-place when using cups such as fountain drinks. Although the mentioned patent alleviates issues of spilling beverages, the cup-shaped sealable design would provide a superior and simpler means of preventing spills while providing other benefits as well.

U.S. Pat. No. 4,796,774 involves a lid, for such beverage containers as an aluminum can, that is resealable to allow for the convenience of reclosing the drink container. Similarly, several additional U.S. patents including U.S. Pat. No. 4,219,137, U.S. Pat. No. 4,561,557 have been approved to provide sanitary means of drinking from a container. These patents entail use of spouts to prevent the consumers'mouth from touching the area of the lid exposed to the outside. Furthermore, U.S. Pat. No. 4,090,660, like U.S. Pat. No. 4,796,774, involves a lid that may be attached to conventional beverage containers and function to provide a spout and reseal the container. These inventions, however, involve having a reusable lid on a conventional container, rather than having a container and lid as one unit that is marketed together. Although this instant invention does not involve a spout, the sanitary concerns are considered as the lid covers the portion that will be exposed to the consumers'mouth.

When consumers buy a snack item, they often want a beverage to go along with it and vice versa. Selecting a drink and also a snack item often takes extra time because of the many choices and often different locations of food and drink in a store. Marketing strategies such as selling beverages alongside snack items work to encourage consumers to buy both types of products. This is particularly appealing given the large number of corporations that market both snacks and drinks. This invention would provide a beverage with an attached snack item for an all-inclusive and quick snack idea. Ideas for complete snacks may include, but are not limited to, milk/iced coffee/tea and cookies, juice and pretzels, soda and chips/chocolates, or even puddings and perishable foods along with a beverage.

Although prior inventions have focused on combination food and beverage containers, many of the patents involve either reusable containers that the consumer could fill with food and beverage by oneself, or single-use containers that are filled on-site (at the store), rather that factory sealed and more durable and airtight. This instant invention presents an alternative and new process or means of dispensing food and beverage such that the retailer may sell the product ready-to-go for the consumers'instant enjoyment. The wide-mouthed shape for the container also has added benefits of preventing the need to pour from a bottle to an adventitious cup or glass (for those whom prefer to drink from cups, for more formal occasions, and for efficacy of packaging, handling and enjoying the product).

The following prior art involve combination food and beverage containers. U.S. Pat. No. 5,960,973 and 6,079,586 both involve the packaging of food in association with a beverage yet have a number of disadvantages. U.S. Pat. No. 5,960,973 relates to the use of a clip to attach food and beverage, yet lacks the convenience of being housed in a single, easily carried container. Although this prior art does encourage marketing of food and beverage, this instant invention has the advantage of having food and beverage in contiguous housing such that it could be easily stacked, sold through vending machines, and efficiently used where surface space is limited. U.S. Pat. No. 6,079,586 involves a cup-shaped combination food and beverage container that too has disadvantages not shared by this instant invention. This prior art involves a durable multiple-use item that houses food and drink side-by-side. The intention is for the items to be refilled at home or work, not factory assembled for convenience. This instant invention similarly involves housing food and drink in a cup-shaped vessel. Yet, the intention is for single-use primarily to serve as a product for consumer convenience of purchasing food and beverage on-the-go or at leisure in primarily factory assembled combinations.

U.S. Pat. No. 5,310,072, 5,180,079, and 5,573,131 involve snack and beverage units that house both to allow for the convenience of eating and drinking using only one hand. In U.S. Pat. No. 5,310,072, the vessel involves a container for snacks, which is presumably non-disposable, and may be attached to a standard beverage container such as an aluminum can. In contrast, U.S. Pat. No. 5,180,079 involves a unit that combines a drinking cup with a built-in straw, with a container above that holds the snack food. Both of the aforementioned patents involve a reusable snack container that is somehow attached to a beverage container. U.S. Pat. No. 5,573,131 involves a container to hold a drinking cup with a compartment for a snack above. This prior art serves to provide convenient handling of beverage and snack in a movie-theatre-type setting, but is not resilient enough for travel and use elsewhere. Unlike these patents, this instant invention involves a single-use snack item and a single-use (or reusable) beverage container that are detachable and resealable and thus convenient for people who must snack on the go and may wish to save drink for later.

U.S. Pat. No. 5,209,348 and 5,727,679 involve a container for housing dry food and liquid. These patents differ from the instant invention since they are specifically for cereal and milk. While U.S. Pat. No. 5,209,348 is reusable, U.S. Pat. No. 5,727,679 is a single-use item and more specifically was designed to have the dry and wet contents “mixed together immediately prior to consumption”.

U.S. Pat. No. 5,664,671 involves a combination container that includes a beverage container resting over an edible solid container, connected by heat-shrunk material. This prior art addresses the need to package dissimilar items together for ease of consumption. Latent in the claims of said prior art is the need to package the edible solid below the beverage container, since the openings of traditional beverage containers would not permit the attachment of an edible solid container above the beverage compartment. The instant invention solves this limitation and permits the attachment of an edible solid directly over the beverage compartment, due to the wide opening of said beverage container in the instant invention. The instant invention presents a novel and significant benefit over said prior art in that the limitations of packaging the edible solid below the beverage compartment are many. Notably, beverages are significantly heavier than the edible solids that are proposed to be consumed with them. Therefore, said prior art would present a significant logistic problem in shipping and storage, since the edible solids are likely to be crushed when they rest below a beverage. This limitation could theoretically be overcome by using stronger packaging materials, but this would then result in increased cost of manufacture and distribution. The instant invention solves the problem of maintaining the edible solids in saleable condition while minimizing costs of manufacture and distribution. The wide opening in the instant invention also is more conducive to the consumption of beverages such as tea and coffee that are traditionally consumed concomitantly with edible solids.

U.S. Pat. No. 5,613,620 involves a machine that co-dispenses both beverages and snack items. This involves having a refrigerated machine that sells beverages in the form of a can, for instance, with snack foods that are sold in a similar sized packaging. This type of one-stop shopping saves time for the consumer and encourages sales of both food and drink. The instant invention could provide a similar service through a dispensing machine, yet the consumer could place money in the machine only once, push a single button, and receive this complete snack.

No other patent is similar in its utility as a cup-shaped beverage container with a lid that can be sold with a snack, and contains a lid that is resealable to prevent spillage

As far as environmental concerns, the beverage container is recyclable as any other beverage container, yet would eliminate the need for use of additional cups, whether of paper, plastic or Styrofoam. The snack packing could either be made of resilient materials that are also recyclable, or it may be disposed of directly. It is to be understood that the phraseology and terminology used herein are for the purposes of description and should not be regarded as limiting.

### DESCRIPTION OF THE DRAWINGS

FIG. 1. Represents a plain view of the beverage container with the food container above. 1. A tab lid that may be peeled off of the food container 2. A generally cylindrical food container resting atop the beverage 3. A twist-style cap to seal the beverage container, which is depicted here with corrugations for better grip, but may also be less corrugated. The cap may also be a snap top. 4. A cylindrical body that tapers at the base and provides a wide mouth for drinking. Although illustrated as a smooth cylindrical body, the container may also be contoured and is not limited to any size or shape cup. Other vessel shapes may include shapes such as a glass, mug, can, wine flute or any variety of drinkable cups. 5. The base of the container may be flat on bottom or contoured, and may be of lesser diameter than the mouth of the vessel, and may fit in traditional-sized cup holders.

FIG. 2. Represents the beverage container from slightly above, without the lid. 6. Threading on the vessel's outer neck to provide for a twist closure. Although this illustration shows a container with a twist/threaded closure, this invention may also involve a non-threaded or snap type closure, and includes but is not limited to the illustrated closure. 7. A lip on the lower portion of the vessel's neck to act as a catch to stop the threading and assure tight twist of the lid to prevent loss of carbonation or prevent spillage

FIG. 3. Cup-shaped vessel to house food items. Viewed from slightly above, with the peel lid pulled partially off 2. A generally cylindrical food container resting atop the beverage 8. A tab lid that may be peeled off of the food container

FIG. 4. Cross-section of the food container that is separate but attached to the beverage lid. 101. Beverage container lid with corrugated inner wall to provide for a twist/screw-on seal 102. Cylindrical or cup-shaped food container resting flush on top of lid

FIG. 5. Cross-section of the food container that is a part of the beverage lid, as one unit 103. Lip of the food container to provide for a snap or pop-on lid of any resilient material 104. The beverage container lid that extends into a cup-shaped vessel atop 105. Lid for the food container. Made of a resilient material of any size, shape or form

FIG. 6. Packaged food item atop the beverage container lid. Cross-section of the lid, plain view of the food item. 106. Flexible packaging to envelope the food item. The packaging may also be bagged or otherwise sealed in wrapping 101. Beverage container lid with corrugated inner wall to provide for a twist/screw-on seal

FIG. 7. View of lid from slightly above demonstrates the tamper resistant button on top as well as corrugated sidewalls of lid to enable friction for easier opening of container

FIG. 8. Cross-sectional view of cap with threading on the inside to complement threading on the outer wall of the vessel lip as illustrated in prior figures (though threading may be on inner lip of vessel and outer surface of lid)

FIG. 9. Front plain view of cup-shaped vessel with a resealable lid. Note again that the pictures illustrate a traditional frusta-conical tapered shape, though the shape may vary and include corrugations

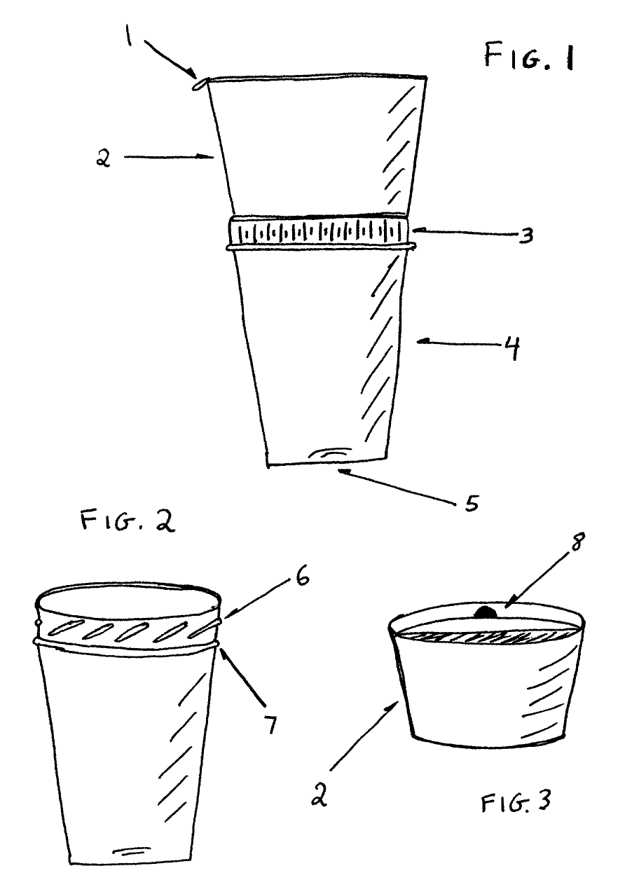

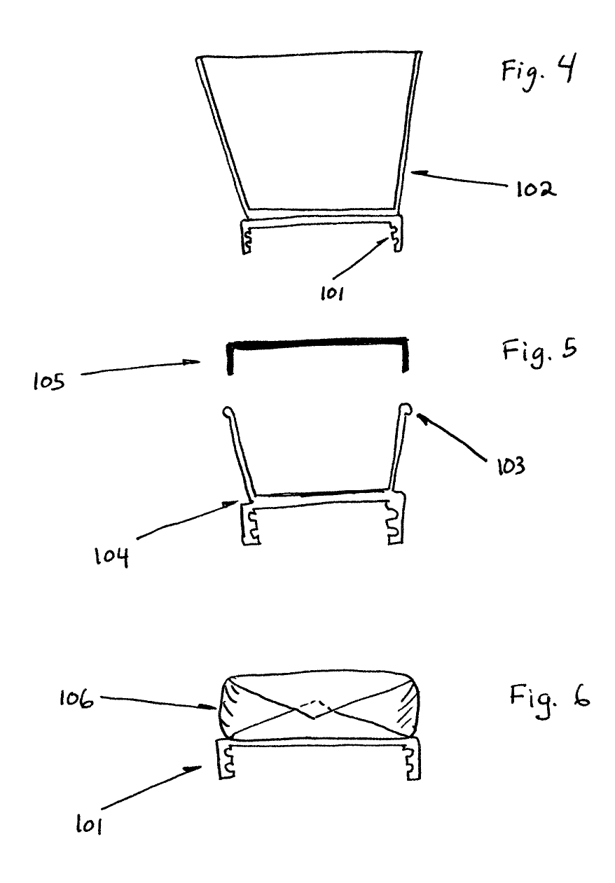

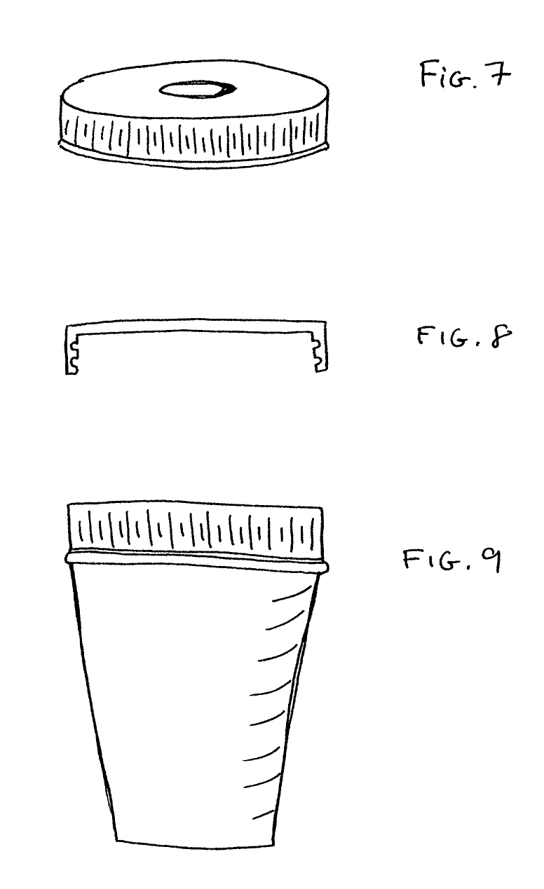

### SUMMARY OF INVENTION

This invention involves a resealable wide-mouthed beverage container that may have a snack food attached or above. Although the beverage and snack container may be any size or shape as long as the opening is wide (including but not limited to cup, carafe, mug, glass, flute or stein ), the preferable shape would be that of a cup. The beverage container could contain milk, coffee, juices, teas, sodas, beer, or other liquids. The snack atop the beverage could be cup-shaped or wrapped in flexible materials like traditional cookie or chocolate packages. Snack items could include dry foods such as chips, cookies and candies, but could also include puddings, canned fruits and eventually more substantial foods such as pastas, rice and vegetables or even sandwiches. This invention could be widely used, whether at home, work, or in social settings. The beverage container would provide a more elegant form of a traditional container for drinks, while the added snack offers the convenience of providing a complete snack in a convenient and easily handled form.

There would be no more limitations to its distribution than comparable beverage or snack foods, and these packages could be sold on a supermarket shelf, in multiple-packs or in beverage or snack machines. Another convenient use would be for snack service on airplanes or for meetings/conferences or outings.

We claim the following:

1. An improved beverage container (Product 1) comprising in combination:
a generally cylindrical body made of a resilient material (such as but not limited to polyurethane, glass, aluminum) of a variety of sizes and shapes
said container with an open top to form a wide opening from which the said beverage may be drunk directly from or poured. The diameter of the container neck is larger than traditional bottle necks and thus a wide mouth, yet not necessarily equal or greater in diameter than the container's base
the body of the vessel may be in the form of a cup, mug, can, glass, flute of any shape or size; including corrugated or contoured shapes allowing for ease of handling, enhanced visual appeal, or practicality of containing the liquid
the lid of said container comprising a circular depressed button on said upper lid, wherein or ring on the lid lower that twists off the lid portion, but not limited to this form of tamper resistance to assure safety of the contents
the lid may further comprise an additional opening to allow for drinking while the lid remains sealed on the vessel
the neck or resilient outer ridge or opening of the said body (Product 1) has a threaded, grooved or smooth lip wherein said outer ridge may meet a lid to form a seal; and the neck of the said container is of a subtle nature to not interfere with convenience of drinking, while providing ability to tightly seal the beverage container to prevent spills
the threading may be either on the outer or inner surface of the container.
a straw or extended lip may be included to enable drinking from the container when it is not practical to have the entire lid removed.

2. An improved combination container for housing a food item in association with a beverage container comprising:
first and second operative portions; of which may be sold empty for consumer use or ready to drink/eat
said first portion including a generally frusta-conical or cylindrical body (Product 1) as described in claim 1 with means of becoming attached or standing adjacent to second operative portion atop or below
said second portion further including resilient material (such as glass, plastic, paper, aluminum) in the shape of a cylinder or cup; or flexible packaging (such as plastics, paper, foil or other wraps) to envelop the item housed within second operative portion
said second portion including a means of attaching the snack item to the beverage which may entail adhesive materials or an extended portion of the cap that forms a cup or other cylindrical housing that may be upside-down or right-side up and contiguous with the aperature and perimeter of second container (second operative portion)
said second portion further including a lid to seal contents of said portion by means of tear or peel-off closure around perimeter of first operative
said second portion also involving a generally frusta conical or cylindrical body contiguous with said first portion
said first portion made of resilient material with upper sidewalls defining the perimeter of said first portion aperture, and contiguous with lower sidewall perimeter of second portion of lid.

3. In combination:
a frusta-conical container that generally is tapered down from top to bottom of said second container
a lid or closure befitting the upper portion or lip of the container in claim 1 that will act to seal the vessel to hold in the liquid contents; the lid may serve as both a closure for first portion and as the vessel defined as second portion.
the lid is contiguous with the lip of the said container and may comprise multiple characteristics of closure including
an upper piece that is made of any resilient material (including metal or polymer) to secure the liquid contents, whether under pressure or not.
the lid in claim 1 further comprising threading within the inner or outer aspect of said lid to serve as complement threading on the vessel rim or lip to form a means of securement and seal
